(19) United States
(12) Patent Application Publication
(10) Pub. No.: US 2009/0114053 A1
(43) Pub. Date: May 7, 2009

(54) Arm part of an industrial robot as well as an industrial robot provided therewith

(75) Inventors: Pierre Mikaelsson, Shanghai (CN); Bo Toresson, Koping (SE); Magnus Hellberg, Eskilstuna (SE); Michael Fors, Vasteras (SE); Mats Thulin, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 11/991,453

(22) PCT Filed: Oct. 23, 2006
(86) PCT No.: PCT/SE2006/001197

§ 371 Date: Mar. 5, 2008

(30) Foreign Application Priority Data
Oct. 21, 2005 (EP) 05109813.5
Oct. 21, 2005 (EP) 05109820.0

(51) Int. Cl. B25J 18/00

(52) U.S. Cl. 74/490.05; 74/490.03; 901/28; 901/42; 901/19

(57) ABSTRACT

An arm part of a manipulator of an industrial robot has at each end thereof a connector for connecting the arm part to a gear and a stiffener for stiffening the end region of the arm part. At least one aperture is arranged in a hollow structure of the stiffener for providing access to connecting members.

### TECHNICAL FIELD OF THE INVENTION

The present invention relates to the design of an industrial robot.

### PRIOR ART

The lower arm of an industrial robot is the arm interconnecting the so-called second and third axis of an industrial robot, in which these axis have an horizontal extension when the robot stands on the ground (an horizontal surface). The invention relates to all types of industrial robots having such a lower arm, such as for spot welding, milling, packaging and other types of load handling and so on.

Such a lower arm already known is illustrated in appended FIG. 1 showing an industrial robot provided therewith. This robot has a base 1 for mounting it on a floor or the like and a frame 2 rotatably connected to the base about a first vertical axis 3 of rotation. The lower arm 4 is in its turn rotatably connected to the frame 2 about a horizontal second axis 5 of rotation and connects rotatably to an upper arm 6 about a horizontal third axis 7 of rotation. The robot also includes a fourth, fifth and sixth axis of rotation schematically indicated by 8, 9 and 10, respectively. However, it is within the scope of the present invention that the industrial robot does not have all these axis of rotation, but it is only necessary that it has said second and third axis of rotation, and one or more of the others may be left out.

The lower arm 4 has at each end thereof means for connecting the arm to a gear, and these means are for the robot shown in FIG. 1 obtained by flat portions 11 provided with holes and bolts for securing the arm to the gear in question. The arm has to have a certain stiffness in the end regions thereof, and this may be obtained by making said flat portions 11 thick enough, but that would add substantially to the weight of this lower arm, so that stiffening is instead or as a complement thereto obtained by providing an outer material rim 13 surrounding said flat portions. This material rim 13 is combined with a certain thickness of said portions for obtaining the stiffness required.

An arm part according to the preamble of appended claim 1 is known through WO 96/31325.

### SUMMARY OF THE INVENTION

The object of the present invention is to provide an arm part of a manipulator of an industrial robot being improved.

This object is according to the invention obtained by providing an arm part of a manipulator of an industrial robot according to the preamble of claim 1, which is characterized in that at least one aperture is arranged in the hollow structure of said stiffening means for providing access to connecting members included in said connecting means.

This makes it possible to arrange some of the connecting members “internally” of the stiffening means and still tightening and loosening these connecting members for obtaining the required stability of the connection to the gear.

According to an embodiment of the invention at least one of said arm part ends at least a part of said connecting means is located closer to the periphery of the arm part than said stiffening means while at least partly surrounding the stiffening means as seen in the direction of the axis of rotation of said gear, said connecting means comprises substantially flat arm portions to be secured to a said gear and belong to said part of said connecting means located closer to the periphery of the art part than said stiffening means, said connecting means comprises holes arranged in said flat arm portions for connecting the arm by elongated said connecting members, such as bolts or the like, to a said gear, and said aperture is arranged to provide access to said connecting member located most distant to the end of the arm part with respect to the longitudinal extension of the arm part.

According to an embodiment of the present invention said stiffening means forms together with other portions of the arm part an arm part being hollow over substantially the entire length thereof, which will make the arm part lighter for a predetermined stiffness thereof than would it have been solid, and the hollow arm portions may advantageously be prolonged to form the stiffening means at each arm end thanks to the arrangement of the connecting means closer to the periphery of the arm part.

According to an embodiment of the invention said part of said connecting means has an arc-like extension located at the outer part of the arm part with respect to the longitudinal extension of the arm part and surrounding said stiffening means located internally with respect to said arc, and said arc-like extension of said connecting means part may be circular. This means that the connecting means, have changed place with the stiffening rim in the lower arm already known shown in FIG. 1, which opens up for a greater freedom to design the stiffening means located internally thereof, such as making them hollow.

According to another embodiment of the invention said connecting means extend substantially according to a circle as seen in said direction of the axis of rotation of said gear, and said stiffening means is located inside said circle at least at the outer part of the arm part with respect to the longitudinal extension of the arm part. This constitutes a favourable way of securing the arm part to the gear while making it possible to design the stiffening means for obtaining a high stiffness with little material thanks to the arrangement thereof inside said circle at least at the outer part of the arm part.

According to another embodiment of the invention both ends of the arm part are provided with connecting means at least a part of which being located closer to the periphery of the arm part than said stiffening means while at least partly surrounding the stiffening means as seen in the direction of the axis of rotation of said gear for benefiting to an optimum of the advantages of the invention for the arm part so constructed.

According to another embodiment of the invention said arm part is a lower arm of an industrial robot.

The invention also relates to an industrial robot provided with an arm part according to the invention. Such an industrial robot may be made lighter for a certain stiffness, so that costs may be saved for example by reducing the need of material and/or of motor torques.

The design of an arm part of the robot according to the invention allowing the robot to be made lighter for a certain stiffness results in the possibility to provide and industrial robot according to an embodiment of the invention adapted to carry a tool and/or a load with a weight exceeding 100 kg, in which the motor and the gear box arranged at the so-called second axis, i.e. the horizontal axis closest to the base of the robot when arranging the robot on a horizontal surface, are dimensioned, while considering the weight and design of the robot parts as of this axis and to a said tool and/or load applied on the robot and including these, to alone deliver the torques and forces necessary for enabling movements to be carried out by robot parts for fulfilling the function of the robot without any need of any counter-balancing means in connection with this axis. Thus, the present inventors have realized that it is really an option to leave out counter-balancing means in a robot of this type resulting in a number of advantages. The cabling in the region of the first and second axis will be easier to carry out without any obstructing counter-balancing means. The possible movement pattern of the robot will be enlarged, since robot parts will not be stopped in their movement by hitting upon the counter-balancing means. This means that the robot may also be arranged on a shelf for carrying out work close to the level of the base thereof or even lower. Furthermore, the need of maintenance of any counter-balancing means will disappear, and there is no risk of degraded function of the robot as a result of an inappropriate operation of the counter-balancing means. This also means that the industrial robot may be hanged upside down, which due to the gravitation has been out of question for a robot having a counter-balancing means, which opens up for a possibility to arrange robots of this type at a higher density increasing the efficiency of a robot system including several such robots. Another advantage of an industrial robot according to the invention is that it will be possible to mount a robot of this type by use of another robot, which is not possible for a robot having a counter-balancing means. A further advantage is the reduced risk of accidents when for instance replacing the motor.

According to another embodiment of the invention the industrial robot is adapted to be dressed for spot welding and to carry a said tool in the form of a spot welding gun.

The invention also relates to a robot system for spot welding of a work piece including a plurality of industrial robots dressed for spot welding, which is characterized in that it comprises a plurality of industrial robots according to the invention, and at least one of said robots is arranged on a different level and/or has the base differently orientated than one or more other of the robots. Such an arrangement and orientation of at least one of the robots is possible thanks to the freedom to arrange a robot of this type according to above. This means that this robot system may more efficiently utilize the floor surface and space available in a factory in which spot welding is taken place than such robot systems including industrial robots of this type already known and having counter-balancing means.

According to an embodiment of the invention at least one of said robots is arranged to hang upside down with said base on top, which reduces the floor surface required for such a robot system and also may improve the possibilities to reach parts of a work piece difficult to get access to.

According to another embodiment of the invention at least one of said robots of the robot system is arranged upside down with the base on top and at a lower level than the base of another robot standing on the base. This constitutes another preferred possibility to arrange industrial robots according to the invention in a robot system for spot welding.

According to another embodiment of the invention at least one of said robots of the robot system is standing on the base thereof with the base at a substantially higher level than the base of one or more other of the robots for carrying out spot welding of said work piece close to the level of said base or below said base. This robot system utilizes the so called semi-shelf capability of an industrial robot according to the invention.

According to another embodiment of the invention the robot system is designed to carry out spot welding on a car body within the automobile industry. The advantages of an industrial robot according to the invention may be of particular importance when using it to form such a robot system.

Other preferred features and advantages of the present invention will appear from the following description.

### BRIEF DESCRIPTION OF THE DRAWINGS

With reference to the appended drawings, below follows a specific description of embodiments of the invention cited as an examples.

In the drawings:

FIG. 1 is a schematic view illustrating an industrial robot having a lower arm already known,

FIG. 2 is a perspective view of an industrial robot provided with a lower arm according to an embodiment of the present invention,

FIG. 3 is a side elevation of the lower arm according to the invention of the robot shown in FIG. 2,

FIG. 4 is an enlarged perspective view of one end of the lower arm shown in FIG. 3,

FIG. 5 is a perspective view of the industrial robot according to FIG. 2 provided with a spot welding gun,

FIG. 6 is a simplified view illustrating the principle of a robot system according to an embodiment of the invention, and

FIG. 7 is a view corresponding to FIG. 4 of a robot system according to another embodiment of the invention.

### DETAILED DESCRIPTION OF EMBODIMENTS OF THE INVENTION

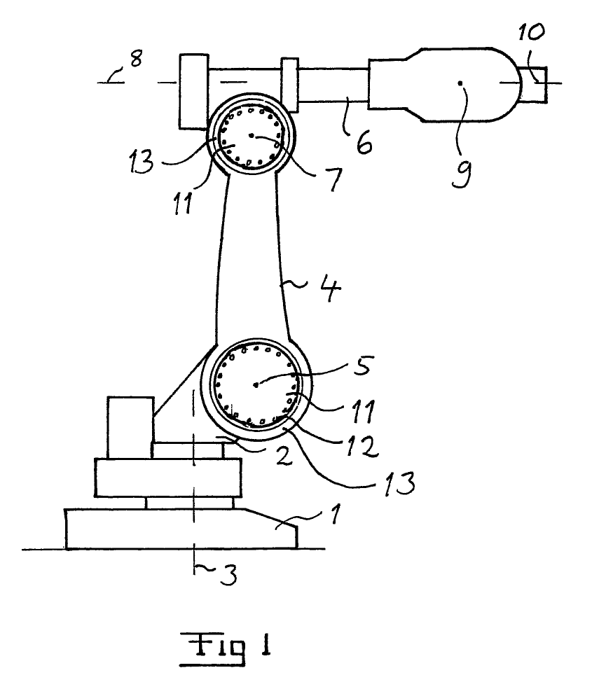

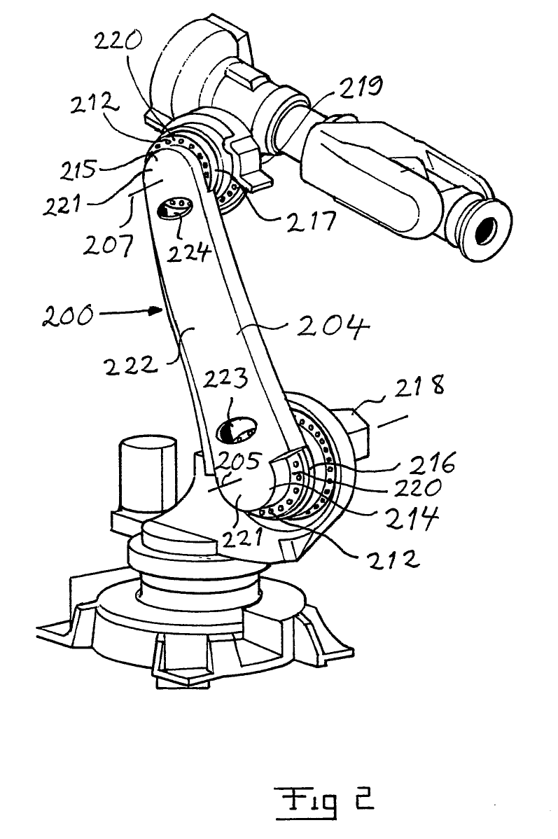

FIG. 2 illustrates schematically an industrial robot having a manipulator 200 provided with an arm part in the form of a lower arm according to an embodiment of the present invention, and robot parts corresponding to robot parts of the robot already known an shown in FIG. 1 have been provided with the same reference numerals with an addition of 200 thereto. It is pointed out that a lower arm according to the invention may be applied to industrial robots having a design being totally different than the one shown in FIG. 2. The industrial robot according to FIG. 2 may for instance be dressed for spot welding or load handling. The lower arm 204 is at each end 214, 215 connected to a gear 216, 217 by connecting members in the form of bolts 212. Motors connected to the respective gear for rotation of the respective end of the lower arm about the second axis 205 and the third axis 207 are shown at 218 and 219.

The connecting means further comprises substantially flat arm portions 220 to be secured to the respective gear through said bolts according to an arrangement thereof along a circle on these arm portions. These flat arm portions are arranged at the periphery of the arm at the outer part of the arm with respect to the longitudinal extension of the arm.

The lower arm has at each end thereof stiffening means in the form of a hollow structure 221 surrounded by said flat arm portions 220 at said outer end of the arm. The stiffening means is formed by making the lower arm hollow over substantially the entire length thereof, so that less material may be used for obtaining a predetermined stiffness of the arm than would the arm be solid. Furthermore, the stiffening means formed by the ends of a shell 222 making the arm hollow results in an increased stiffness of the end regions of the arm without increasing the weight thereof or a lighter end region of the lower arm for a predetermined stiffness. An aperture 223, 224 is arranged in the hollow structure at each end of the lower arm 204 for providing access to the bolts 212 located most distant to the end of the arm with respect to the longitudinal extension of the arm, so that it will be possible to tighten and loosen also these bolts.

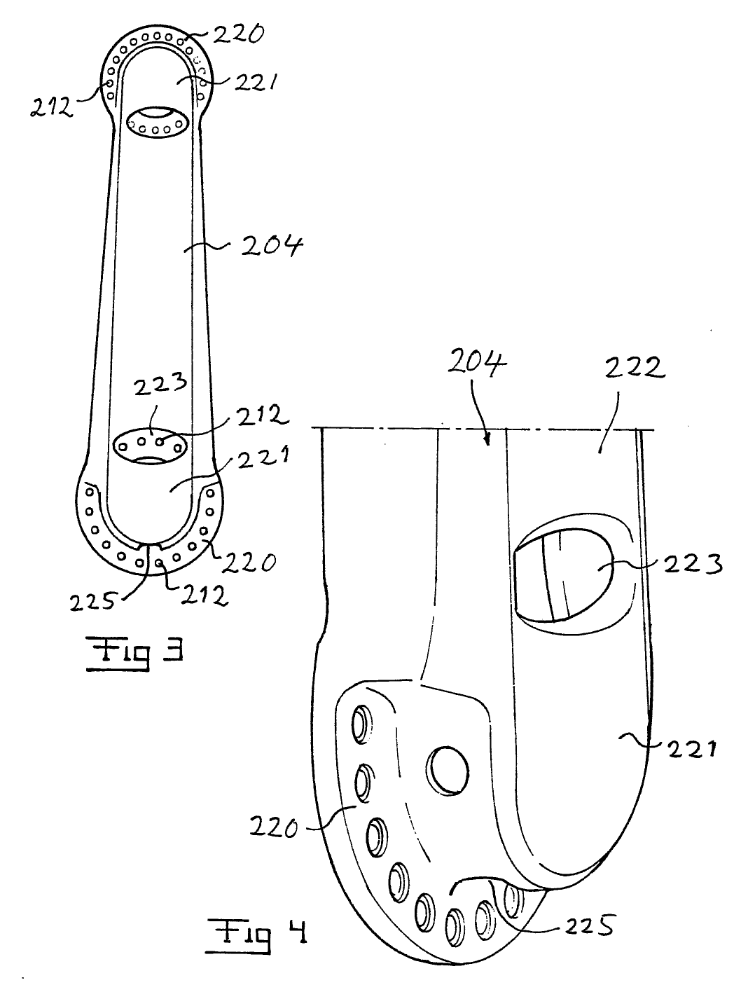

Furthermore, it appears from FIG. 4 that an opening 225 is also provided at the respective end of the shell 222 for making it possible to remove parts, such as bolts, accidentally lost inside the hollow structure from the interior thereof.

Other advantages of providing the lower arm with a hollow structure of this type are that cabling may easily be hidden inside the arm when dressing the robot, and that the lower arm looks longer than lower arms already known having the same length, which may be an important feature from the aesthetic point of view. The cabling may be led through the second axis 205 and then either inside or outside the lower arm 204 or outside the second axis as well as the lower arm. It may also be led either outside or through the third axis 207 and outside or inside the upper arm.

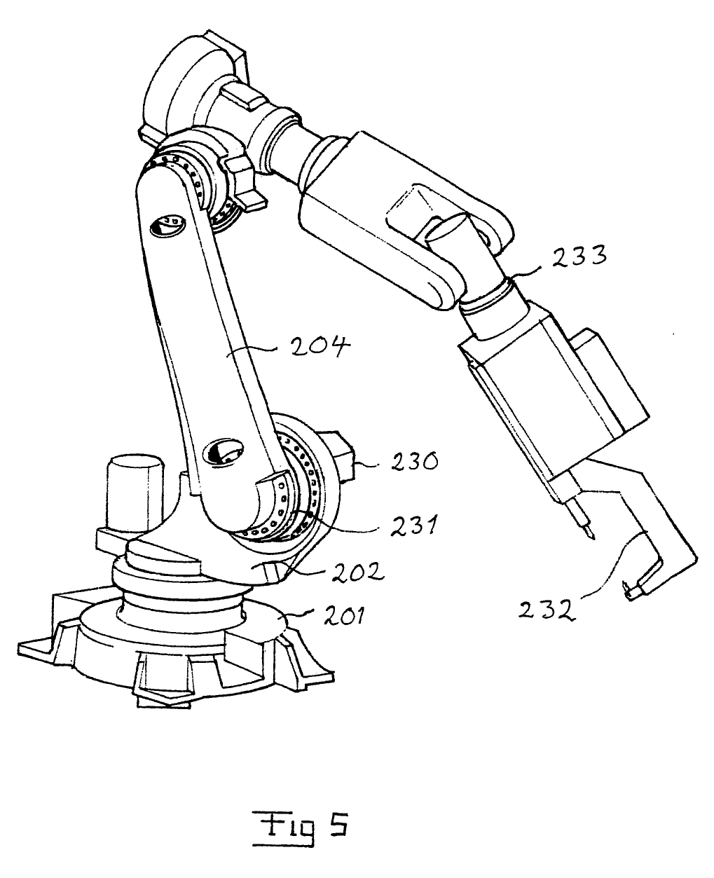

It is illustrated in FIG. 5 how an industrial robot provided with a light structure thanks to the design of the lower arm 204 thereof is provided with a spot welding gun 232 secured to the tool flange 233 thereof. This robot is well suited to be used in BiW (Body in White=within the automobile industry) for carrying out spot welding work on a car body. This robot has in spite of the comparatively heavy spot welding gun with a weight in the order of 150 kg, no counter-balancing means, and the motor 230 and the gear box 231 arranged at said second axis 205 are dimensioned to alone deliver the torques and forces necessary for enabling movements to be carried out by robot parts for fulfilling the function of the robot. This dimensioning is done while considering the weight and design of the robot parts as of this axis 205 and to a said tool and/or load applied on the robot and including these. Besides the lower arm also other parts of the robot have been made partly or fully hollow or otherwise designed so as to keep the weight of the robot parts as of the second axis 205 as low as possible. This means that the motor 230 and the gear box 231 have not to be over-dimensioned that much with respect to the case of having a counter-balancing means in a conventional robot for fulfilling the function of the robot. The increased costs of the motor and the gear box are in fact lower than the costs for the counter-balancing means in the form of a gas accumulator.

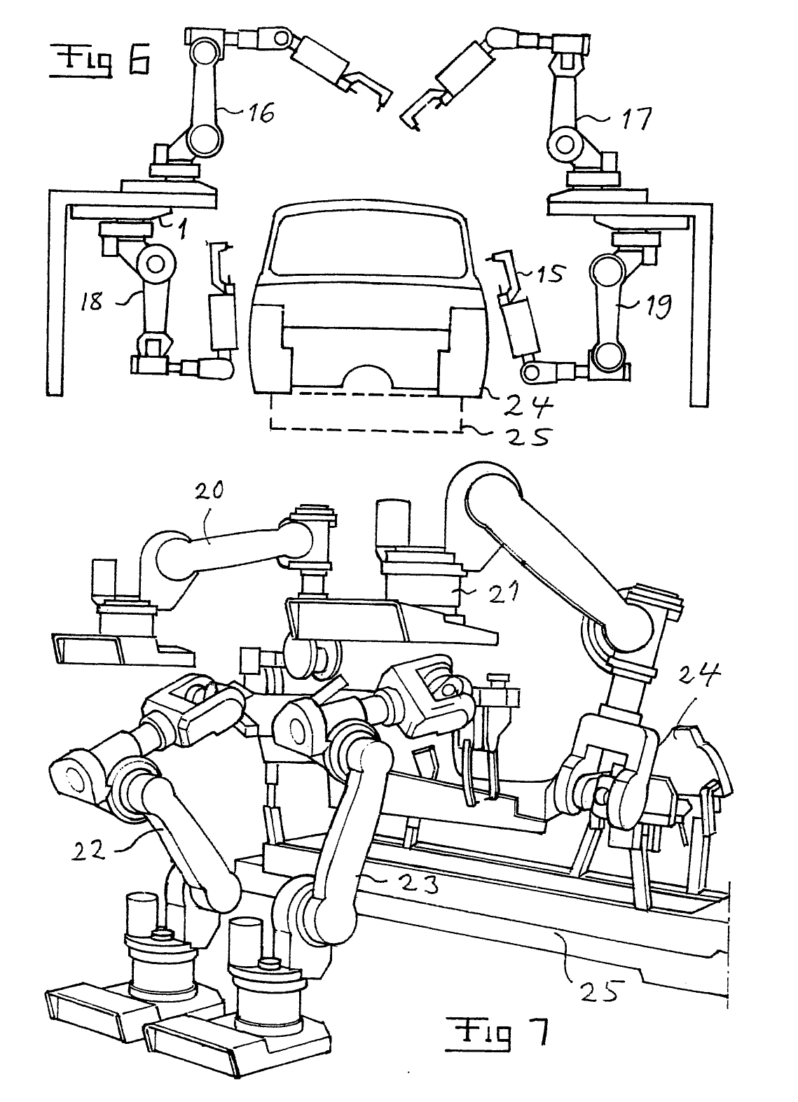

A robot system including a number of robots of the type shown in FIG. 5 used for this purpose is schematically illustrated in FIG. 6. It is shown how some of the robots 16, 17 are standing on a pedestal, whereas other robots 18, 19 are hanging upside down by securing the base 1 thereof to a horizontal surface directed downwards. This way of arranging the robots is possible thanks to the lack of counter-balancing means, which have made the arrangement upside down impossible owing to the influence of the gravitation. This means in its turn that the robots may be arranged at a higher density saving floor space required for the robot system. This freedom to arrange the robots also makes it possible to get better access to parts of the car body 24 otherwise difficult to reach.

FIG. 7 illustrates a robot system according to another embodiment of the invention including a number of robots according to the present invention arranged for carrying out spot welding on a car body 24 moving on a conveyor 25 on a production line within the automobile industry. This robot system comprises industrial robots 20, 21 standing on the base thereof with the base at a substantially higher level than the base of the other robots 22, 23, such as standing on a shelf, and these robots are adapted carry-out spot welding of the car body close to the level of the base thereof or below said base. This is made possible thanks to the so called semi-shelf capability of an industrial robot according to the invention made possible by the extended movement pattern thereof with respect to the movement pattern of such robots already known and having a counter-balancing means.

The invention is of course not in any way restricted to the embodiments described above, but many possibilities to modifications thereof would be apparent to a person with ordinary skill in the art without departing from the basic idea of the invention as defined in the appended claims.

It is not necessary that both ends of the arm part are provided with stiffening means and connecting means arranged according to the invention, but it is also within the scope of the invention to provide only one end of the arm part therewith.

1. An arm part of a manipulator of an industrial robot, the arm part comprising:
a connector at each end of the arm part, the connector being configured to connect the arm part to a gear,
a stiffener configured to stiffen the end region of the arm part, at least a part of said stiffener being designed to form a hollow portion of the arm part at at least one end of the arm part,
at least one aperture arranged in the hollow structure of said stiffener for providing access to connecting members included in said connector.

2. The arm part according to claim 1, wherein at at least one of said arm part ends at least a part of said connector is located closer to a periphery of the arm part than said stiffener while at least partly surrounding the stiffener with respect to a direction of an axis of rotation of said gear, wherein said connector comprises substantially flat arm portions to be secured to one of said gears and to be part of said connecting means located closer to the periphery of the arm part than said stiffener, that said connector comprises holes arranged in said flat arm portions for connecting the arm part by elongated said connecting members to one of said gears, and wherein said aperture is arranged to provide access to said connecting member located most distant to the end of the arm part with respect to a longitudinal extension of the arm part.

3. The arm part according to claim 1, wherein said stiffener forms together with other portions of the arm part an arm part being hollow over substantially the entire length thereof.

4. The arm part according to claim 2, wherein said part of said connector has an arc-like extension located at an outer part of the arm part with respect to the longitudinal extension of the arm part and surrounding said stiffener located internally with respect to said arc.

5. The arm part according to claim 4, wherein said arc-like extension of said part of said connector is circular.

6. The arm part according to claim 1, wherein said connector extends substantially according to a circle with respect to a direction of an axis of rotation of said gear, and wherein said stiffener is located inside said circle at least at an outer part of the arm part with respect to a longitudinal extension of the arm part.

7. The arm part according to claim 1, wherein at least a part of the connector at both ends of the arm part is located closer to a periphery of the arm part than said stiffener while at least partly surrounding the stiffener with respect to a direction of an axis of rotation of said gears.

8. The arm part according to claim 1, wherein the arm part is a lower arm of an industrial robot.

9. The industrial robot, comprising:
an arm part, the arm part comprising a connector at each end of the arm part, the connector being configured to connect the arm part to a gear, a stiffener configured to stiffen the end region of the arm part, at least a part of said stiffener being designed to form a hollow portion of the arm part at at least one end of the arm part, and at least one aperture arranged in the hollow structure of said stiffener for providing access to connecting members included in said connector.

10. The industrial robot according to claim 9, wherein the industrial robot is adapted to carry a tool and/or a load with a weight exceeding 100 kg, wherein a motor and a gear box arranged at a horizontal second axis closest to a base of the robot when arranging the robot on a horizontal surface, are dimensioned, while considering a weight and design of robot parts as of the second axis and to said tool and/or load applied on the robot and including the tool and/or the load, to deliver torques and forces necessary for enabling movements to be carried out by robot parts for fulfilling function of the robot without any need of any counter-balancing means in connection with this axis.

11. The industrial robot according to claim 10, wherein the robot is adapted to be dressed for spot welding and to carry a said tool comprising a spot welding gun.

12. A robot system for spot welding of a work piece including a plurality of industrial robots dressed for spot welding, the robot system comprising:
a plurality of industrial robots each comprising a base and an arm part, each arm part comprising a connector at each end of the arm part, the connector being configured to connect the arm part to a gear, a stiffener configured to stiffen the end region of the arm part, at least a part of said stiffener being designed to form a hollow portion of the arm part at at least one end of the arm part, and at least one aperture arranged in the hollow structure of said stiffener for providing access to connecting members included in said connector, wherein at least one of said robots is arranged on a different level and/or has the base differently orientated than one or more other of the robots.

13. The robot system according to claim 12, wherein at least one of said robots is arranged to hang upside down with said base on top.

14. The robot system according to claim 13, wherein at least one of said robots is arranged upside down with the base on top and at a lower level than the base of another robot standing on the base.

15. The robot system according to claim 12, wherein at least one of said robots is standing on the base thereof with the base at a substantially higher level than the base of one or more other of the robots for carrying out spot welding of said work piece close to the level of said base or below said base.

16. The robot system according to claim 12, wherein the robot system is designed to carry out spot welding on a car body in an automobile manufacturing facility.
